(19) United States
(12) Patent Application Publication
(10) Pub. No.: US 2014/0216504 A1
(43) Pub. Date: Aug. 7, 2014

(54) SILICON WAFER CLEANING METHOD

(71) Applicant: UNITED MICROELECTRONICS CORPORATION, Hsinchu (TW)

(72) Inventors: Jun XIA, Singapore (SG); Hui LU, Singapore (SG); Li-Sen QIAN, Singapore (SG); Chee-Wei TAN, Singapore (SG)

(73) Assignee: UNITED MICROELECTRONICS CORPORATION, HSINCHU (TW)

(21) Appl. No.: 13/760,068

(22) Filed: Feb. 6, 2013

(51) Int. Cl. B08B 3/04

(52) U.S. Cl. CPC B08B 3/04
USPC 134/26

(57) ABSTRACT

A silicon wafer cleaning method is provided. Firstly, a silicon wafer is provided. Then, a polymer cleaning step is performed to clean a surface of the silicon wafer. After the polymer cleaning step, a deionized water/carbon dioxide gas discharging step is performed, so that the charges accumulated on the surface of the silicon wafer can be instantly removed. After the deionized water/carbon dioxide gas discharging step, two or more particle removing steps are performed. In addition, an air-jet step is performed during the time interval between every two sub-steps of a single particle removing step. Consequently, the cleaning efficiency of removing the particles will be enhanced.

### FIELD OF THE INVENTION

The present invention relates to a wafer cleaning method, and more particularly to a wet cleaning method for cleaning a surface of a silicon wafer.

### BACKGROUND OF THE INVENTION

As known, the process of manufacturing an integrated circuit on a semiconductor wafer comprises many steps such as etching, oxidation, deposition, photoresist removal, chemical mechanical polishing (CMP), and so on. After each of these processing steps is performed, contaminants are readily formed on surface of the semiconductor wafer. Consequently, it is necessary to frequently clean the surface of the semiconductor wafer in order to remove the contaminants. As the device size and the thickness of the gate oxide layer are gradually developed toward miniaturization, the demands on the cleanness of the wafer surface become more stringent.

The purpose of a wafer surface cleaning technology is to remove all trace contaminants on the wafer surface and controlling the oxide film on the wafer surface. The contaminants include, for example, organic substances, polymers, metals, particles, and so on.

A popular surface cleaning sequence for cleaning the surface of a semiconductor wafer with a gate structure comprises three steps, including a cleaning step of using a sulfuric acid/ozone mixture (abbreviated as the SOM step), a cleaning step called a Standard Clean 1 step (abbreviated as the SC1 step) and an air-jet step. However, after the SOM step, a large number of charges are easily accumulated on the wafer surface. After the subsequent cleaning steps are performed, more charges are accumulated on the surface of the semiconductor wafer. If the amount of the accumulated charges on the wafer surface exceeds a saturation level, a volcano effect occurs. Under this circumstance, the structure of the wafer surface is thereby damaged.

Therefore, there is a need of providing an improved silicon wafer cleaning method so as to eliminate the above drawbacks.

### SUMMARY OF THE INVENTION

The present invention provides a silicon wafer cleaning method for increasing the yield of the semiconductor device on a silicon wafer.

The present invention also provides a silicon wafer cleaning method for efficiently cleaning a silicon wafer.

In accordance with an aspect, the present invention provides a silicon wafer cleaning method. Firstly, a silicon wafer is provided. Then, a polymer cleaning step is performed to clean a surface of the silicon wafer. After the polymer cleaning step, a deionized water/carbon dioxide gas discharging step is performed to clean the surface of the silicon wafer. After the deionized water/carbon dioxide gas discharging step, a particle removing step and an air-jet step are performed to clean the surface of the silicon wafer.

In accordance with another aspect, the present invention provides a silicon wafer cleaning method. Firstly, a silicon wafer is provided. Then, a polymer cleaning step is performed to clean a surface of the silicon wafer. After the polymer cleaning step, a first particle removing step is performed to clean the surface of the silicon wafer. After the first particle removing step, an air-jet step is performed to clean the surface of the silicon wafer. After the air-jet step, a second particle removing step is performed to clean the surface of the silicon wafer.

From the above discussions, the present invention provides a silicon wafer cleaning method. After a polymer cleaning step, a deionized water/carbon dioxide gas discharging step is performed. Alternatively, a single polymer cleaning step is separated into two or more sub-steps, which are performed during different processing time intervals. After the first sub-step of the polymer cleaning step is performed, the deionized water/carbon dioxide gas discharging step and a next sub-step of the polymer cleaning step are sequentially performed. Consequently, the electric charges accumulated on the surface of the silicon wafer can be instantly removed. Since the charge accumulation is largely alleviated, the amount of the electric charges accumulated on the surface of the silicon wafer in the subsequent cleaning steps will not result in the volcano effect. Moreover, a single particle removing step is separated into two or more sub-steps which are performed during different processing time intervals. In addition, an air-jet step is performed during the time interval between every two sub-steps of the single particle removing step. Consequently, the cleaning efficiency of removing the particles will be enhanced, and the particles adsorbed on the surface of the silicon wafer can be removed.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a flowchart of a silicon wafer cleaning method according to an embodiment of the present invention;

FIG. 1B is a schematic cross-sectional view illustrating a silicon wafer to be cleaned by the silicon wafer cleaning method of FIG. 1A;

FIG. 2A is a flowchart of a silicon wafer cleaning method according to an another embodiment of the present invention;

FIG. 2B schematically illustrates the relationship between the accumulated charge amount of the wafer surface and the processing time of the steps 220a˜234b of the silicon wafer cleaning method as shown in FIG. 2A;

FIG. 3A is a flowchart of a silicon wafer cleaning method according to yet another embodiment of the present invention;

FIG. 3B schematically illustrates the relationship between the particle removal efficiency of the wafer surface and the processing time of the steps 240a˜250b of the silicon wafer cleaning method as shown in FIG. 3A; and

FIG. 3C schematically illustrates the relationship between the etch rate of the wafer surface and the processing time of a single particle removing step.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

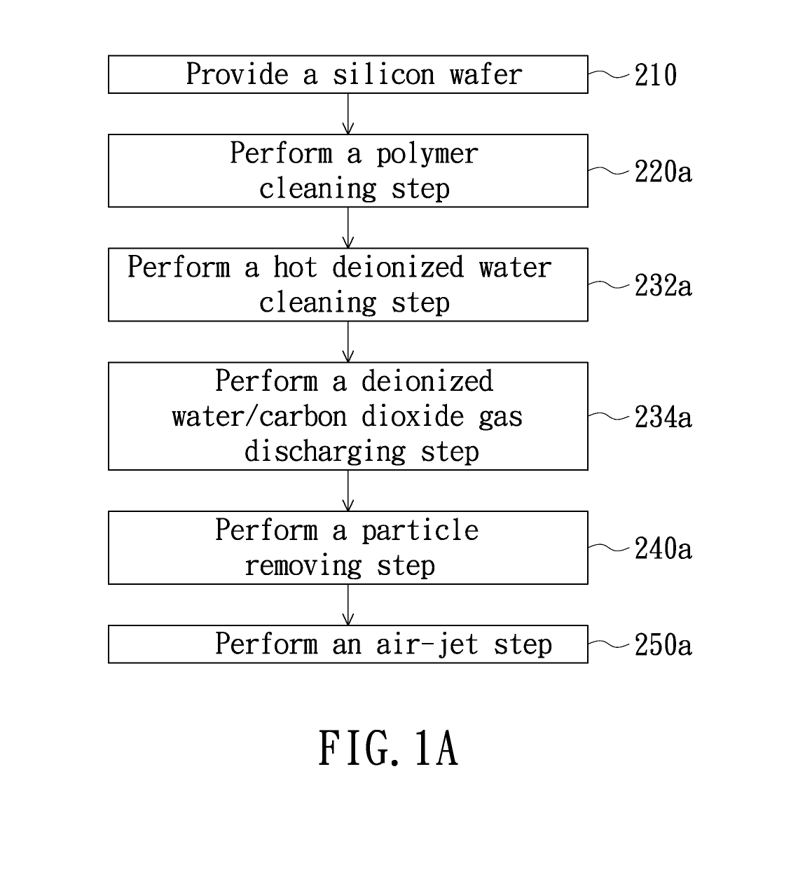

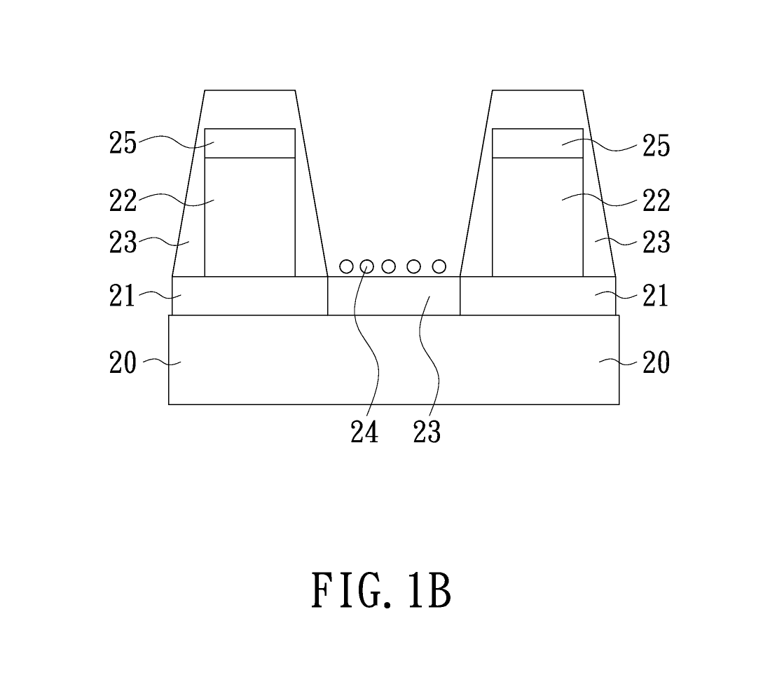

FIG. 1A is a flowchart of a silicon wafer cleaning method according to an embodiment of the present invention. FIG. 1B is a schematic cross-sectional view illustrating a silicon wafer to be cleaned by the silicon wafer cleaning method of FIG. 1A. Please refer to FIGS. 1A and 1B. Firstly, a silicon wafer 20 is provided (Step 210). Moreover, a silicon gate structure including a plurality of parts 21, 22 and 25 are formed on a surface of the silicon wafer 20. Then, a polymer cleaning step 220a is performed. In the polymer cleaning step 220a, a cleaning agent containing a sulfuric acid/ozone mixture (SOM) is used to remove a polymer 23 which has been formed on the surface of the silicon wafer 20 by a prior processing step. Hereinafter, the polymer cleaning step 220a using the sulfuric acid/ozone mixture (SOM) is also referred as a SOM cleaning step.

After the polymer cleaning step 220a is performed, a hot deionized water cleaning step 232a and a deionized water/carbon dioxide gas electric discharging step 234a are sequentially performed to clean the surface of the silicon wafer 20. After the deionized water/carbon dioxide gas discharging step 234a, a particle removing step 240a and an air-jet step 250a are sequentially performed to clean the surface of the silicon wafer 20.

In the hot deionized water cleaning step 232a, the deionized water (DI water) at 70° C. is used. The deionized water/carbon dioxide gas discharging step 234a is performed at room temperature of about 25° C. The particle removing step 240a is for example a Standard Clean 1 step (also referred as a SC1 step). In the SC1 step, a mixture of ammonium hydroxide (NH₄OH), hydrogen peroxide (H₂O₂) and DI water is used to oxidize the silicon atoms on the surface of the silicon wafer 20 and slightly etching the surface of the silicon wafer 20. Consequently, a plurality of particles 24 adsorbed on the surface of the silicon wafer 20 can be removed. The air-jet step 250a is used for removing the silicon oxide and the particles 24 remained on the surface of the silicon wafer 20, and drying the surface of the silicon wafer 20.

The operating principles of the cleaning steps (220a, 232a, 234a) of the silicon wafer cleaning method as shown in FIG. 1A will be illustrated in more details as follows. After the polymer cleaning step 220a, the temperature of the surface of the silicon wafer 20 is about 150° C. If the temperature of the silicon wafer 20 is abruptly decreased, the surface of the silicon wafer 20 may result in defects. For avoiding abrupt temperature decrease, it is preferred that the surface of the silicon wafer 20 is washed by hot DI water. That is, after the polymer cleaning step 220a, the hot deionized water cleaning step 232a is performed. Moreover, a large number of charges are readily accumulated on the surface of the silicon wafer 20 after the polymer cleaning step 220a. Since the deionized water and carbon dioxide gas discharging step 234a is immediately performed after the hot deionized water cleaning step 232a, the charges accumulated on the surface of the silicon wafer 20 can be instantly removed. Since the charge accumulation is largely alleviated at the end of the deionized water and carbon dioxide gas discharging step 234a, the amount of the charges accumulated on the surface of the silicon wafer 20 in the subsequent cleaning steps will not result in the volcano effect. Under this circumstance, the possibility of causing damages to the parts 21, 22 and 25 of the silicon gate structure on the surface of the silicon wafer 20 will be minimized.

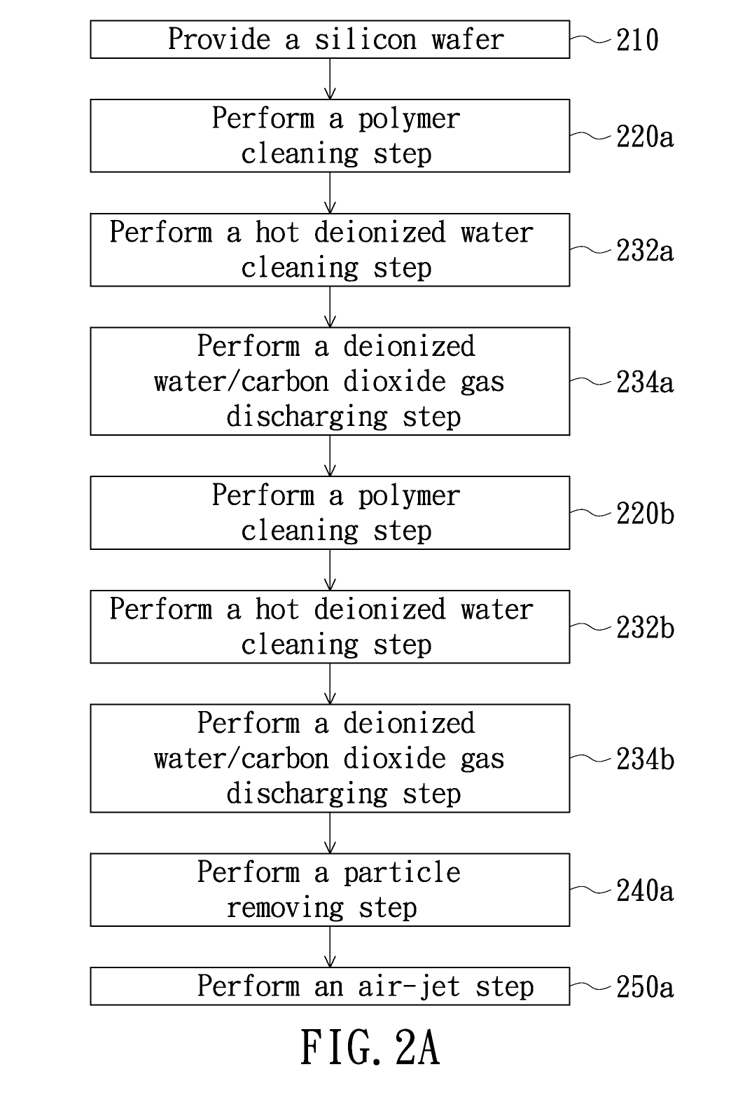

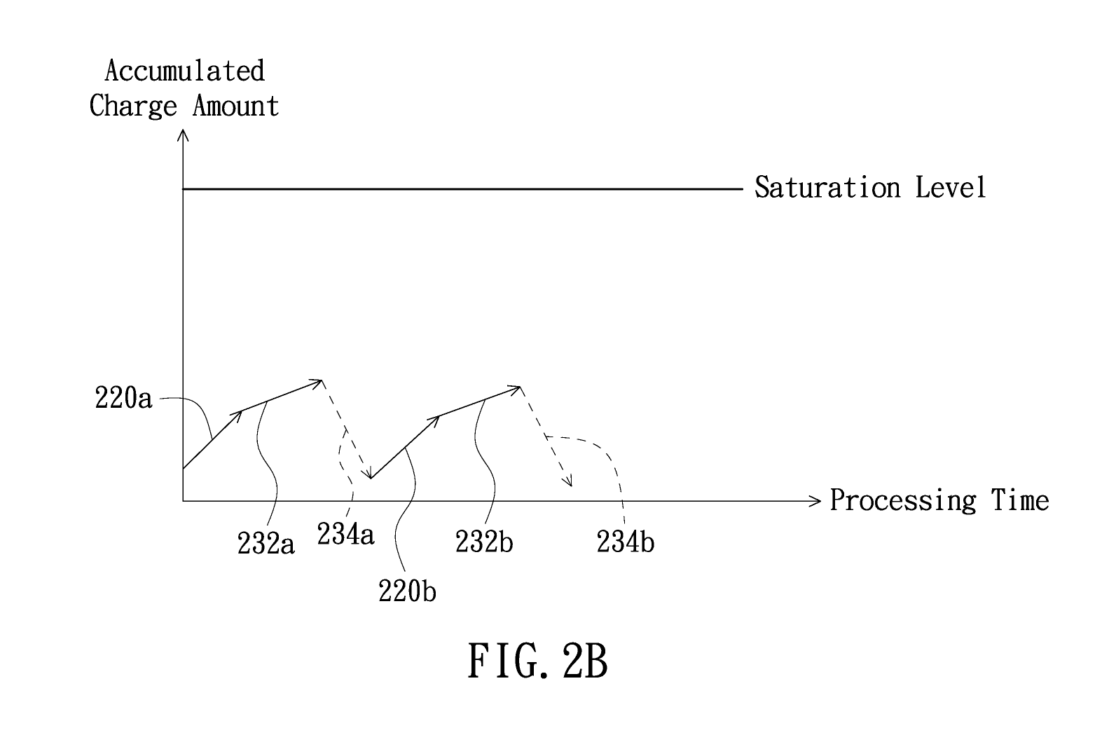

FIG. 2A is a flowchart of a silicon wafer cleaning method according to an another embodiment of the present invention. Firstly, a silicon wafer is provided (Step 210). Then, a polymer cleaning step 220a, a hot deionized water cleaning step 232a and a deionized water/carbon dioxide gas discharging step 234a are sequentially performed. Then, at least one process cycle including the polymer cleaning step 220b, the hot deionized water cleaning step 232b and the deionized water/carbon dioxide gas discharging step 234b is repeatedly performed in that order. According to the practical requirements, the at least one process cycle may be one cycle, two cycles or more than two cycles. Then, a particle removing step 240a and an air-jet step 250a are sequentially performed.

In this embodiment, the polymer cleaning steps 220a and 220b may be considered as two sub-steps of a single polymer cleaning step. That is, the single polymer cleaning step is separated into two or more sub-steps, which are performed during different processing time intervals. Moreover, after the first sub-step of the single polymer cleaning step (i.e. the polymer cleaning step 220a) is performed, the deionized water/carbon dioxide gas discharging step 234a is performed to instantly remove the accumulated charges from the surface of the silicon wafer 20. Alternatively, after each sub-step of the polymer cleaning step is performed, a subsequent deionized water/carbon dioxide gas discharging step can be performed. Consequently, the efficacy of the removing the accumulated charges from the surface of the silicon wafer can be enhanced.

FIG. 2B schematically illustrates the relationship between the accumulated charge amount of the wafer surface and the processing time of the steps 220a˜234b of the silicon wafer cleaning method as shown in FIG. 2A. In FIG. 2B, the vertical axis denotes the accumulated charge amount, and the horizontal axis denotes the processing time of various steps. Moreover, in FIG. 2B, the data for the polymer cleaning steps 220a and 220b are obtained from data collected at the SOM cleaning steps. As shown in FIG. 2B, since the deionized water/carbon dioxide gas discharging step 234a is immediately performed after the polymer cleaning step 220a and the hot deionized water cleaning step 232a, the accumulated charge amount on the surface of the silicon wafer is thereby largely reduced. Similarly, since the deionized water/carbon dioxide gas discharging step 234b is immediately performed after the polymer cleaning step 220b and the hot deionized water cleaning step 232b, the accumulated charge amount on the surface of the silicon wafer is thereby largely reduced. In other words, by using the silicon wafer cleaning method of the present invention, the accumulated charge amount on the surface of the silicon wafer can be effectively decreased to be under the saturation level, thereby avoiding the volcano effect of charges.

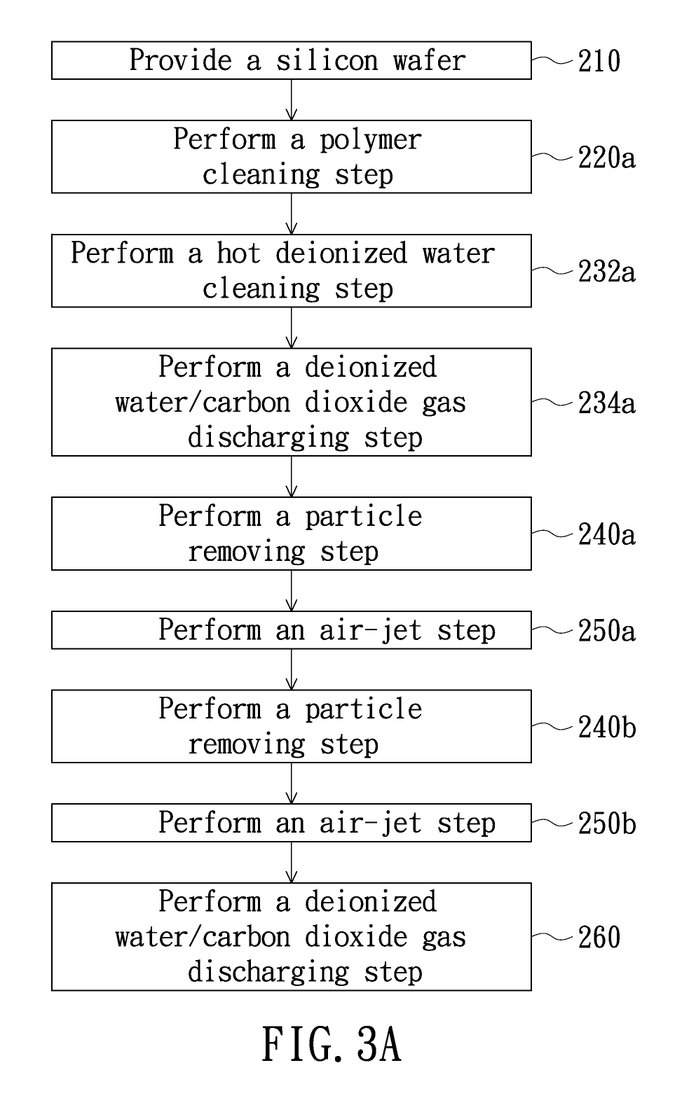

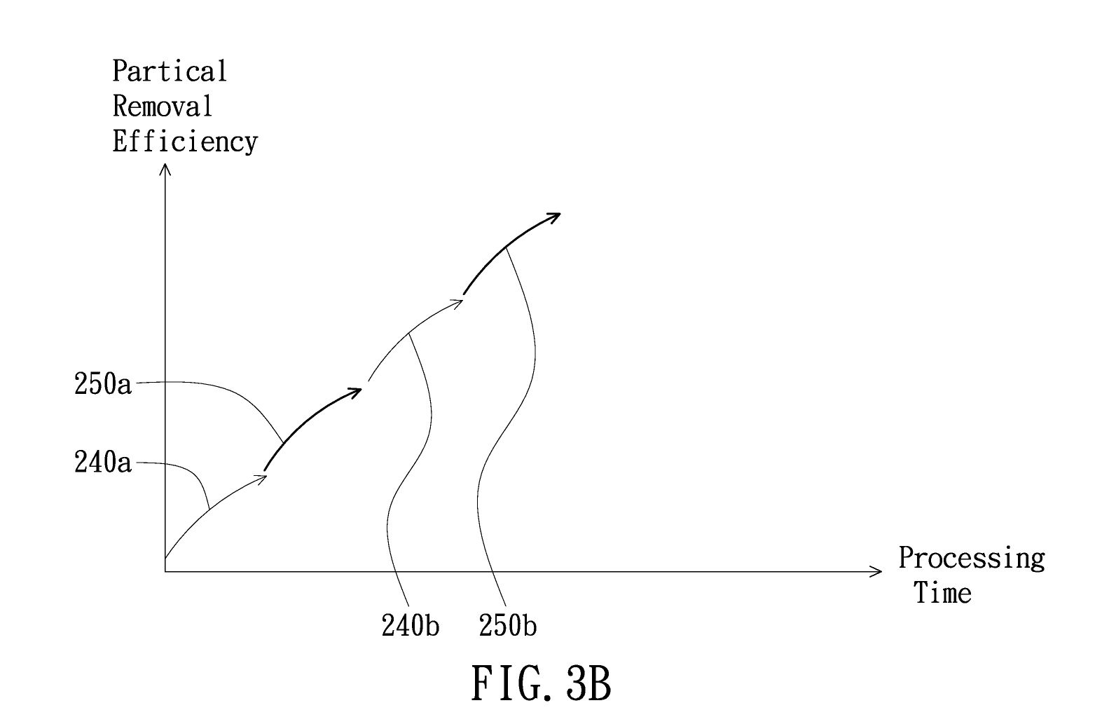

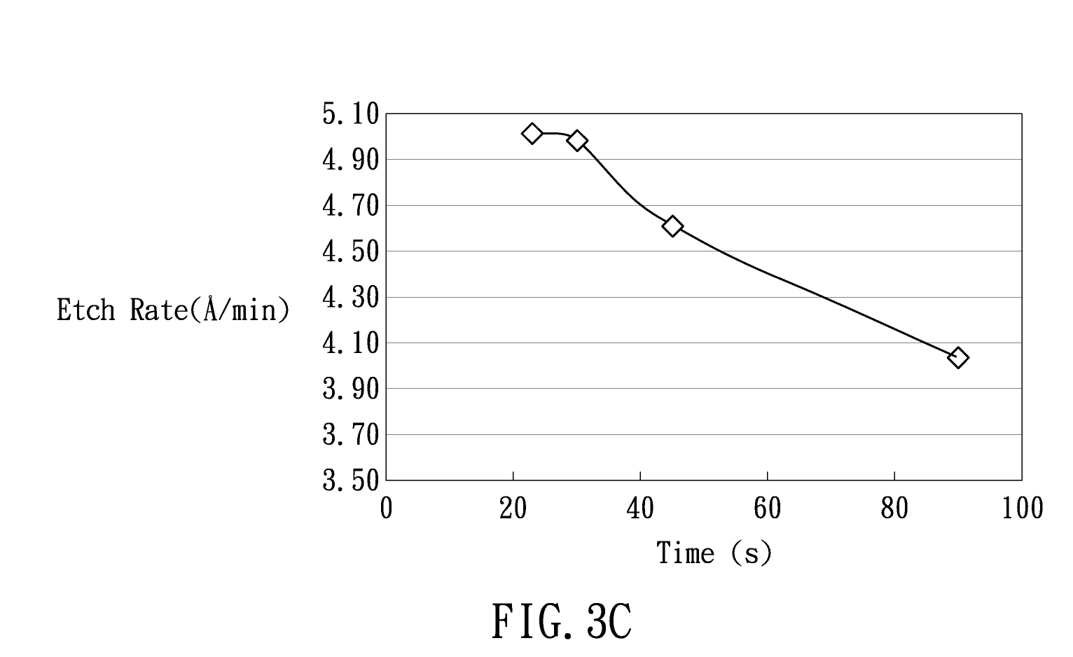

FIG. 3A is a flowchart of a silicon wafer cleaning method according to a yet another embodiment of the present invention. Firstly, a silicon wafer is provided (Step 210). Then, a polymer cleaning step 220a, a hot deionized water cleaning step 232a and a deionized water/carbon dioxide gas discharging step 234a are sequentially performed. Then, a particle removing step 240a and an air-jet step 250a are sequentially performed. Then, at least one process cycle including the particle removing step 240b and the air-jet step 250b is performed in that order. According to the practical requirements, the at least one process cycle may be one cycle, two cycles or more than two cycles. Afterwards, a deionized water/carbon dioxide gas discharging step 260 is performed to remove the residual electric charges from the surface of the silicon wafer. In FIG. 3A, the cleaning steps performed before the particle removing step 240a are similar to those described in FIG. 1A. Alternatively, the cleaning steps performed before the particle removing step 240a as shown in FIG. 2A may be applied to the silicon wafer cleaning method of the yet another embodiment as shown in the flowchart of FIG. 3A.

The operating principles of the cleaning steps (240a, 250a, 240b, 250b) of the silicon wafer cleaning method as shown in FIG. 3A will be illustrated in more details as follows. If the depth of the silicon oxide etched by a single particle removing step is insufficient to completely remove the particles from the surface of the silicon wafer, or if the time period of oxidizing the silicon wafer to form a silicon oxide layer with a specified thickness by a single particle removing step is too long, the silicon wafer cleaning method of the yet another embodiment as shown in FIG. 3A can solve these problems. In this embodiment, the particle removing steps 240a and 240b may be considered as two sub-steps of a single particle removing step. That is, the single particle removing step is separated into two or more sub-steps, which are performed during different processing time intervals, wherein the lengths of the different processing time intervals may be identical or different. Since the time period of oxidizing the silicon wafer is separated into two or more processing time intervals, the purpose of completely removing the particles from the surface of the silicon wafer can be achieved and the cleaning efficiency can be enhanced. After each sub-step of the particle removing step (e.g. the SC1 step) is performed, a subsequent air-jet step is performed. After two or more cycles including the particle removing step (e.g. the SC1 step) and the air-jet step in that order are repeatedly performed, a deionized water/carbon dioxide gas discharging step 260 is performed to remove the residual electric charges. Meanwhile, the whole process of the silicon wafer cleaning method is thereby implemented.

FIG. 3B schematically illustrates the relationship between the particle removal efficiency of the wafer surface and the processing time of the steps 240a˜250b of the silicon wafer cleaning method of the yet another embodiment as shown in FIG. 3A. In FIG. 3B, the vertical axis denotes the particle removal efficiency (or the etch rate of the surface of the silicon wafer), and the horizontal axis denotes the processing time of various steps. Moreover, in FIG. 3B, the data for the particle removing steps 240a and 240b are obtained from data collected at the SC1 steps. As shown in FIG. 3B, the single particle removing step (e.g. the SC1 step) is separated into two or more sub-steps, and a subsequent air-jet step (250a, 250b) is performed after each sub-step of the particle removing step is performed. In other word, by adopting the silicon wafer cleaning method of the present invention, the particle removal efficiency of the wafer surface is largely enhanced.

FIG. 3C schematically illustrates the relationship between the etch rate of the wafer surface and the processing time of a single particle removing step. In FIG. 3C, the vertical axis denotes the etch rate of the surface of the silicon wafer (or the particle removal efficiency), and the horizontal axis denotes the processing time of various cleaning steps. Moreover, the data for the particle removing step are obtained from data collected at the SC1 step. The unit of etch rate is expressed in “angstroms per minute”. The unit of the processing time is expressed in “seconds”. Before 30 seconds of processing time has been reached, the etch rate is maintained at a high level. After the 30 seconds, the etch rate drops with the processing time. In accordance with the present invention, the time period of performing the first SC1 step may be determined according to the length of the processing time before the etch rate starts to drop. For example, as shown in FIG. 3C, the time period of performing the first SC1 step may be set as 30 seconds. After the first SC1 step is performed, a subsequent air-jet step is performed. The time period of performing a next SC1 step may be determined according to the practical requirements and the data of FIG. 3C. Since the surface of the silicon wafer is oxidized and micro-etched during separate processing time intervals, the depth of the film layer to be removed can be correspondingly controlled. Moreover, the cleaning efficiency and the completion efficacy of the particle removing step are enhanced.

More especially, various steps (e.g. the polymer cleaning step, the hot deionized water cleaning step, the deionized water/carbon dioxide gas discharging step, the particle removing step and the air-jet step) of the silicon wafer cleaning method of the present invention may be performed in a same chamber. For example, in the silicon wafer cleaning method of the embodiments as shown in FIG. 1A or FIG. 2A, the polymer cleaning step, the deionized water/carbon dioxide gas discharging step and the particle removing step may be performed in the same chamber. For example, in the silicon wafer cleaning method as shown in FIG. 3A, the polymer cleaning step, the first particle removing step, the air-jet step and the second particle removing step may be performed in the same chamber. Moreover, the silicon wafer cleaning method of the present invention may be used to clean the surface of the silicon wafer before or after the formation of a lightly doped drain (LDD) structure (not shown).

From the above descriptions, the present invention provides a silicon wafer cleaning method. After a polymer cleaning step, a deionized water/carbon dioxide gas discharging step is performed.

Alternatively, a single polymer cleaning step is separated into two or more sub-steps, which are performed during different processing time intervals. After the first sub-step of the polymer cleaning step is performed, the deionized water/carbon dioxide gas discharging step and a next sub-step of the polymer cleaning step are sequentially performed. Consequently, the electric charges accumulated on the surface of the silicon wafer can be instantly removed. Since the charge accumulation is largely alleviated, the amount of the electric charges accumulated on the surface of the silicon wafer in the subsequent cleaning steps will not result in the volcano effect. Moreover, a single particle removing step is separated into two or more sub-steps which are performed during different processing time intervals. In addition, an air-jet step is performed during the time interval between every two sub-steps of the single particle removing step. Consequently, the cleaning efficiency of removing the particles will be enhanced, and the particles adsorbed on the surface of the silicon wafer can be removed.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A silicon wafer cleaning method, comprising steps of:
providing a silicon wafer;
performing a polymer cleaning step to clean a surface of the silicon wafer;
performing a deionized water/carbon dioxide gas discharging step to clean the surface of the silicon wafer after the polymer cleaning step; and
performing a particle removing step and an air-jet step to clean the surface of the silicon wafer after the deionized water/carbon dioxide gas discharging step.

2. The silicon wafer cleaning method according to claim 1, wherein a sulfuric acid/ozone mixture (SOM) is used to clean the surface of the silicon wafer in the polymer cleaning step.

3. The silicon wafer cleaning method according to claim 1, wherein after the polymer cleaning step and before the deionized water/carbon dioxide gas discharging step, the silicon wafer cleaning method further comprises a hot deionized water cleaning step of using hot deionized water.

4. The silicon wafer cleaning method according to claim 3, wherein the hot deionized water is about 70° C.

5. The silicon wafer cleaning method according to claim 1, wherein after the deionized water/carbon dioxide gas discharging step and before the particle removing step, performing the polymer cleaning step again.

6. The silicon wafer cleaning method according to claim 5, wherein after the polymer cleaning step is performed again and before the particle removing step, performing a hot deionized water cleaning step of using hot deionized water, and performing the deionized water/carbon dioxide gas discharging step again.

7. The silicon wafer cleaning method according to claim 6, wherein the hot deionized water is about 70° C.

8. The silicon wafer cleaning method according to claim 1, wherein the particle removing step is a Standard Clean 1 step (SC1 step), wherein the Standard Clean 1 step uses a mixture of ammonium hydroxide (NH₄OH), hydrogen peroxide (H₂O₂) and deionized water to clean the surface of the silicon wafer.

9. The silicon wafer cleaning method according to claim 1, wherein after the air-jet step, performing the particle removing step and the air-jet step again sequentially

10. The silicon wafer cleaning method according to claim 9, wherein after the particle removing step and the air-jet step are sequentially performed again, performing the deionized water/carbon dioxide gas discharging step again.

11. The silicon wafer cleaning method according to claim 1, wherein in the step of providing a silicon wafer, a silicon gate structure is formed on the surface of the silicon wafer.

12. The silicon wafer cleaning method according to claim 1, wherein the polymer cleaning step, the deionized water/carbon dioxide gas discharging step and the particle removing step are performed in a same chamber.

13. A silicon wafer cleaning method, comprising steps of:
providing a silicon wafer;
performing a polymer cleaning step to clean a surface of the silicon wafer;
performing a first particle removing step to clean the surface of the silicon wafer after the polymer cleaning step;
performing an air-jet step to clean the surface of the silicon wafer after the first particle removing step; and
performing a second particle removing step to clean the surface of the silicon wafer after the air-jet step.

14. The silicon wafer cleaning method according to claim 13, wherein each of the first particle removing step and the second particle removing step is a Standard Clean 1 step, wherein the Standard Clean 1 step uses a mixture of ammonium hydroxide (NH₄OH), hydrogen peroxide (H₂O₂) and deionized water to clean the surface of the silicon wafer.

15. The silicon wafer cleaning method according to claim 13, wherein a silicon gate structure is formed on the surface of the silicon wafer in the step of providing a silicon wafer.

16. The silicon wafer cleaning method according to claim 13, wherein after the second particle removing step, performing the air-jet step again.

17. The silicon wafer cleaning method according to claim 16, wherein after the air-jet step is performed again, the silicon wafer cleaning method further comprises performing a deionized water/carbon dioxide gas discharging step.

18. The silicon wafer cleaning method according to claim 13, wherein the polymer cleaning step uses a sulfuric acid/ozone mixture (SOM) to clean the surface of the silicon wafer.

19. The silicon wafer cleaning method according to claim 13, wherein after the polymer cleaning step and before the first particle removing step, performing a hot deionized water cleaning step of using hot deionized water and a deionized water/carbon dioxide gas discharging step sequentially.

20. The silicon wafer cleaning method according to claim 19, wherein the hot deionized water is about 70° C.

21. The silicon wafer cleaning method according to claim 19, wherein after the deionized water/carbon dioxide gas discharging step and before the first particle removing step, performing the polymer cleaning step, the hot deionized water cleaning step, and the deionized water/carbon dioxide gas discharging step sequentially again.

22. The silicon wafer cleaning method according to claim 13, wherein the polymer cleaning step, the first particle removing step, the air-jet step and the second particle removing step are performed in a same chamber.
